(19) United States
(12) Patent Application Publication
(10) Pub. No.: US 2008/0233383 A1
(43) Pub. Date: Sep. 25, 2008

(54) POLYMERIC INSULATING MATERIALS

(75) Inventor: Gary Handwerker, Northfield, IL (US)

Correspondence Address: ROSENBAUM & ASSOCIATES, P.C., 650 DUNDEE ROAD, SUITE #380, NORTHBROOK, IL, 60062, US

(73) Assignee: Midwest Canvas Corporation, Chicago, IL (US)

(21) Appl. No.: 12/051,795

(22) Filed: Mar. 19, 2008

Related U.S. Application Data
(60) Provisional application No. 60/896,808, filed on Mar. 23, 2007.

(51) Int. Cl. B32B 3/26

(52) U.S. Cl. 428/313.3

(57) ABSTRACT

A heat insulating article comprises a first outer polymeric layer and a second outer polymeric layer. At least one of the first outer polymeric layer and the second outer polymeric layer further comprises hollow spherical particles incorporated with the at least one of the first outer polymeric layer and the second outer polymeric layer.

### CROSS-REFERENCE TO RELATED APPLICATIONS

The present application claims the benefit of U.S. Provisional Application Ser. No. 60/896,808, filed Mar. 23, 2007. The aforementioned application is incorporated by reference in it entirety.

### BACKGROUND

Embodiments described herein relate generally to insulating articles such as insulating blankets, covers, tarps or sheeting materials used in the construction trade or to insulating covers for swimming pools and spas. Embodiments described herein also relate to methods for making insulating articles.

In construction applications, particularly in colder weather climates, concrete curing blankets, protective tarps or sheeting are employed to insulate and protect freshly poured concrete slabs or work spaces. It is accepted in the art, that heat generated during concrete curing should be retained adjacent the concrete so as not to compromise the concrete curing process. It is, therefore, desirable to retain heat and moisture in the concrete long enough to permit the curing process to be sufficiently completed. The need for heat and moisture retention increases during cold weather applications. Several approaches to deal with this are taught by Handwerker in U.S. Pat. Nos. 5,549,956; 5,874,150; 5,855,978; 5,780,367; 5,363,605 and 4,413,029 that are directed to flexible, multilayer heat reflective and heat retaining blankets. Each of these patents is incorporated in their entirety herein by reference.

In addition to concrete curing blankets, the embodiments described herein relate to pools and spas and their covers. Spas and hot tubs are popular and some homes incorporate a hot tub or spa. The water within the spa shell is circulated during use, and is subjected to heating and aeration and injected back into the interior of the spa shell. It is desirable that the water temperature be relatively high for its enjoyable and therapeutic effects. When left uncovered, the water rapidly cools with a concomitant loss of both water and chemicals to evaporation. Both hard and flexible insulating covers are known in the art for use with hot tubs or spas. The spa shell itself is supported or surrounded by a vertical perimeter skirt panel, with the upper edge of the skirt panel underlying the rim of the spa shell. In the past, a thermal insulation material such as polyurethane has been sprayed onto the exterior surface of the spa shell to reduce heat loss by convection through the spa shell to the exterior. Rigid insulating covers typically overlie the spa shell and supporting skirt panel to insulate the spa. Typically, flexible covers are dimensioned to overlie only the water surface. Many flexible hot tub or spa covers incorporate a plurality of air pockets formed between two layers of a polymeric material. Air in the air pockets is heated by solar energy and aids in retaining heat within the spa water.

Flexible solar covers similar in construction to the spa covers are used to cover swimming pools. Depending on the size of the pool to be covered, the costs of the various types of lightweight multi-layer covers are relatively expensive. It would be advantageous if a swimming pool cover could be made relatively inexpensively utilizing long-lasting lightweight polymeric film layers, yet having features like reflective integral air-pockets for reflective solar heating and insulation. Several approaches directed to this issue are taught by Handwerker in U.S. Pat. Nos. 6,317,902, 6,286,155, and 5,887,296. Each of these patents is incorporated herein in their entirety by reference.

### SUMMARY

A heat insulating article comprises a first outer polymeric layer and a second outer polymeric layer. At least one of the first outer polymeric layer and the second outer polymeric layer further comprises hollow spherical particles incorporated with the at least one of the first outer polymeric layer and the second outer polymeric layer.

### BRIEF DISCRIPTION OF THE DRAWINGS

FIG. 1 is a schematic representation of a system and method for preparing a HSPF;

FIG. 2 is a schematic representation of a system and method for laminating a HSPF to another material;

FIG. 3 is schematic representation of a system and method for laminating an intermediate layer of material between layers of HSPF;

FIG. 4 is a schematic representation of a system and method for preparing a string-reinforced polymeric sheeting article;

FIG. 5 is a schematic representation of an insulating article having a foam layer and a HSPF layer;

FIG. 6 is a schematic representation of an insulating article having a foam layer intermediate two layers of HSPF;

FIG. 7 is a schematic representation of an insulating article having a reinforcing string mesh, a layer of HSPF and two outer layers of polymeric material;

FIG. 8 is a schematic representation of an insulating article having one layer of HSPF, a metalized layer, and woven polyethylene film layer;

FIG. 9 is a schematic representation of an insulating article having two outer layers of HSPF, a reflective layer and an insulating layer having plural air pockets;

FIG. 10 is a schematic representation of an insulating article having two outer layers of HSPF, a reflective layer and two insulating layers each with plural air pockets;

FIG. 11 is a schematic representation of an insulating article having outer layers of HSPF, two reflective layers and two insulating layers each with plural pockets;

FIG. 12 is a schematic representation of an insulating article having two outer layers of HSPF, three reflective layers and two insulating layers with air pockets;

FIG. 13 is a schematic representation of an insulating article having two outer layers of HSPF, two reflective layers and an intermediate HSPF layer;

FIG. 14 is a schematic representation of an insulating article having a first HSPF layer having convolutions forming air pockets and a second polymeric layer laminated thereto enclosing the air pockets;

FIG. 15 is a schematic representation of side elevational cross-sectional view illustrating plural layers in an insulating article; and

FIG. 16 is a schematic representation of the seam portion of an insulating article.

### DETAILED DESCRIPTION

As used in this application, the term “polymeric bubble sheet” means a multi-layer polymeric sheet having a plurality of air pockets.

The term “hollow spherical particles” or “HSP” comprises glass or ceramic hollow spherical particles that have insulating properties. The HSP preferably have a particle size range from 1 nm to 500 um, with the preferred average particle size range being from 20 to 120 um. The HSPs used in embodiments described herein are fine particles with intrinsic hardness, high-strength and are inert. Suitable glass or ceramic hollow spherical particles are available from 3M Corporation, St. Paul, Minn. In some embodiments, at least one of the HSPs may have a metal coating. The addition of HSP to a resin system can increase or decrease thermal conductivity of the resulting products, depending upon the type and amount of HSP used.

The term “hollow spherical particles film” or “HSPF” means a polymeric film or layer containing HSP. HSPF may be made of a resin or polymer.

The HSPF employed in making an insulating article described herein preferably comprises HSPs present in about 2% to about 35% by weight. In one of the embodiments, the HSPF comprises of HSP about 2% by weight. In another embodiment, the HSPF comprises of HSP about 10% by weight. In another embodiment of the heat insulating article, the HSPF comprises of HSP about 20% by weight. In yet another embodiment, the HSPF comprises of HSP about 30% by weight. In another embodiment, the polymeric material in HSPF is about 20% to about 99% by weight or by volume, and HSP is about 1% to about 80% by weight or by volume.

An embodiment described herein is an improved flexible multilayer polymeric heat reflective article comprising an HSPF for use in concrete curing, construction insulating tarps or sheeting materials, and pool or spa insulating covers. In one embodiment, the polymeric material is a resin. In another embodiment, the polymeric material is a polyester. In another embodiment, polyethylene outer layers are woven polyethylene.

One embodiment described herein comprises polymeric, moisture-impervious, outer surface layers that enclose insulating layers and heat reflective layers, comprising metal particles, metal foil or metal paints, and a HSPF layer.

In another embodiment, the heat insulating article is a concrete curing blanket wherein at least one of the outer layers further includes a metallic coating on one surface of the woven polyethylene material and an opaque polyethylene coating on the opposite surface of the woven polyethylene material.

In another embodiment of the article, the first and second outer layers of the heat insulating article comprise layers of substantially similar size, and wherein the layer of insulating material is of substantially similar size as the sizes of the first and second outer layers. In another embodiment, the top and bottom hems of the article define folded regions in which the at least one layer of insulating material is maintained between the first and second outer layers throughout the folded region. In another embodiment, the folded region comprises a segment in which the first and second outer layers, with at least one insulating layer therebetween, are folded to form a single fold. The folded region may also comprise a segment in which the first and second outer layers, with the at least one insulating layer therebetween, are folded to form a double fold.

Further, the means for securing the hems comprises means for sewing the hems to secure the insulating media. The means for sewing the hems may comprise means for sewing the hems with a plurality of rows of substantially parallel stitches. Further, the means for securing the hems may comprise means for gluing the hems. The means for securing the hems may comprise means for applying a plurality of spaced apart grommets along at least one hem.

In another embodiment, HSPs are added to a polymeric material, such as polyethylene, polypropylene, polyester, polyurethane or the like, to form a hollow spherical particle containing HSPF. The HSPF film is incorporated as a component part of an insulating article, particularly for use in making a concrete curing blanket, a construction tarp or sheeting material, or a swimming pool or spa cover.

Another embodiment is a layered blanket comprising a layer of HSPF further comprises a woven polyethylene layer, an aluminum layer, and a layer of HSPF.

A further embodiment comprises a woven polyethylene layer, metalized or metal layer and a layer of HSPF.

Another embodiment is concrete curing blanket.

Another embodiment is a string reinforced sheeting material.

Another embodiment is a swimming pool or spa cover.

In another embodiment, the heat insulating article is a cover for a swimming pool or spa containing water, wherein at least one of the outer layers has a surface partially in contact with water when the cover is in use. At least one of the layers has a plurality of integral pockets disposed in a predetermined spaced relationship to each other. The pockets have a predetermined shape and size and extend a predetermined distance from a surface of the at least one layer. The layer also includes a reflective surface adapted to reflect heat from the water back towards the water.

In an embodiment comprising a heat insulating cover, the HSPF is about 2% to about 35% HSP by weight. In another embodiment, the HSPF comprises about 2% HSP by weight.

In another embodiment, the HSPF comprises about 10% HSP by weight.

In yet another embodiment, the HSPF comprises about 20% HSP by weight.

Another embodiment of the cover comprises HSPF having about 30% HSP by weight.

Another embodiment provides a method of making a concrete curing blanket comprising the steps of layering a polyethylene woven material, an aluminum sheet, and a layer of HSPF.

In another embodiment, a method of making a concrete curing blanket comprises the steps of layering a polyethylene woven material, metallic painting, and a polyethylene layer containing HSP.

In another embodiment, a method of making a pool or spa cover comprises layering HSPF. In another embodiment, the method further comprises layering a polyethylene woven material.

### EXAMPLES

The following examples illustrate embodiments described herein and related methods.

### Example 1

### HSPF

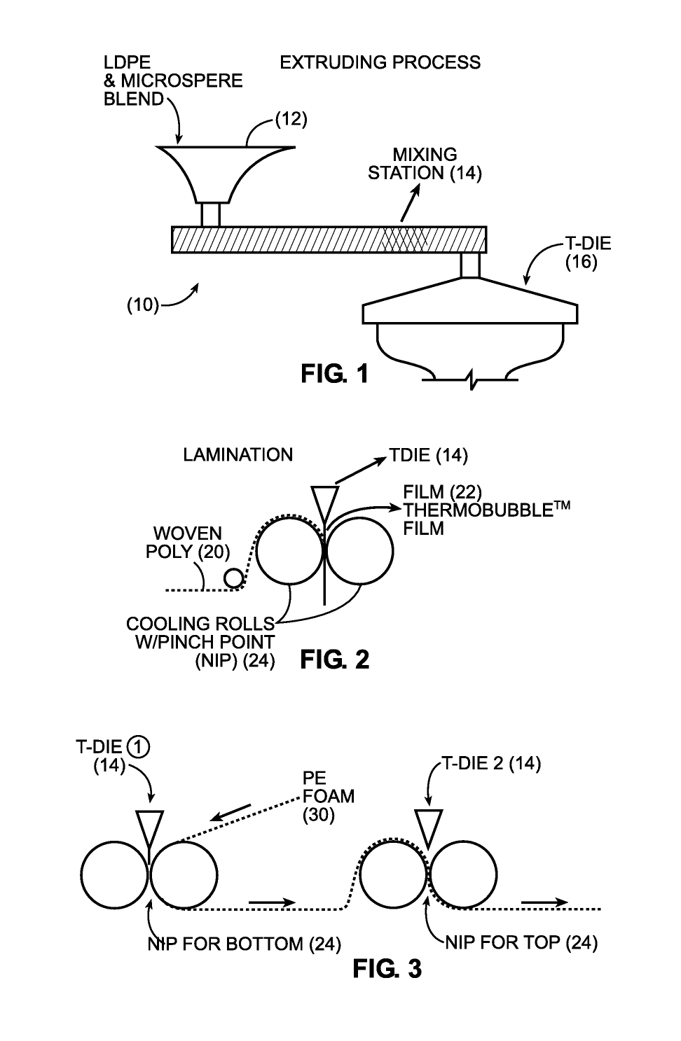

A mixture of low density polyethylene LPDE and the HSP are fed into an extruder 10 as shown in FIG. 1. The mixture is fed into a hopper 12. The material is conveyed to a mixing station 14 by a rotating screw disposed inside a heated barrel and is softened by both friction and heat. The mixture is carried into a T-Die 16 and is extruded as a film and is cooled to hold the HSP rigidly in the polymer. From here, the film is conveyed to take-off rollers, which pull the softened plastic from the T-die 16, as shown in FIG. 2.

The ratio of resin to HSP is variable, such that the polymeric material is present at about 20% to about 99% by weight or by volume, and HSP is present from about 1% to about 80% by weight or by volume.

### Example 2

The HSPF with polyethylene 65% by weight and HSP 35% by weight and is prepared as described in Example 1.

### Example 3

The HSPF with polyethylene 70% by weight and HSP 30% by weight is prepared by the procedure described in Example 1.

### Example 4

The HSPF-with polyethylene 75% by weight and HSP 25% by weight is prepared by the procedure described in Example 1.

### Example 5

The HSPF containing polyethylene 80% by weight and HSP 20% by weight is prepared by the procedure described in Example 1.

### Example 6

The HSPF containing polyethylene 85% by weight and HSP 15% by weight is prepared by the procedure described in Example 1.

### Example 7

The HSPF containing polyethylene 90% by weight and HSP 10% by weight is prepared by the procedure described in Example 1.

### Example 8

The HSPF containing polyethylene 95% by weight and HSP 5% by weight is prepared by the procedure described in Example 1.

### Example 9

The HSPF containing polyethylene 98% by weight and HSP 2% by weight is prepared by the procedure described in Example 1.

### Example 10

### Method 20 of Making One-Side Laminated Article

As depicted in FIG. 2, the HSPF 22 prepared by any of Examples 1-9 is introduced from the T-Die 14 onto an article 26, such as a woven polyethylene article, through a pinch point or NIP 24 to laminate the article 26 with the extruded HSPF on one side, as shown in FIG. 2 to obtain a one-side laminated article 28.

### Example 11

### Method 30 of Making Two-Side Laminated Article

As depicted in FIG. 3, the HSPF 22 prepared by any of Examples 1-9 is introduced from the T-Die 14 onto an article 32 through two pinch points or NIPs 24 to laminate the article 32 with the extruded HSPF 22 on both sides, as shown in FIG. 3. The article 32, for example, a polyethylene foam, goes through first pinch point or NIP 24 to be laminated on one side to form one-side laminated foam 34, which then goes through the second pinch point or NIP 24 to be laminated on the other side to obtain a two-side laminated foam 36.

### Example 12

### Method 40 of Making a Multi Layer Article

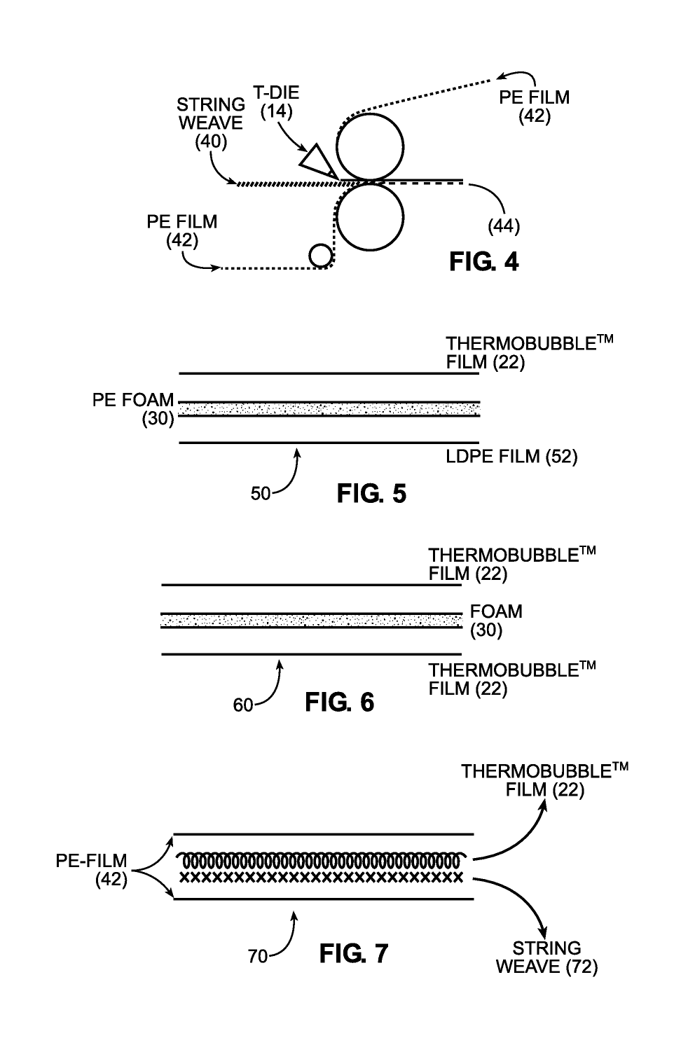

As depicted in FIG. 4, the HSPF 22 from any of Examples 1-9 is introduced from the T-Die 14 onto a pinch point or NIP 24 simultaneously with three articles such as string wave polyethylene film 42, a polyethylene film 44, and another polyethylene film 46, as shown in FIG. 4. The placement of the HSPF film in the sequence can be varied to obtain articles with HSPF either laminated or sandwiched.

### Example 13

In assembling an insulating article 50, as in FIG. 5, the HSPF layer 22, polyethylene foam 32 and the low density polyethylene LPDE film 52 are assembled as described in Example 12.

### Example 14

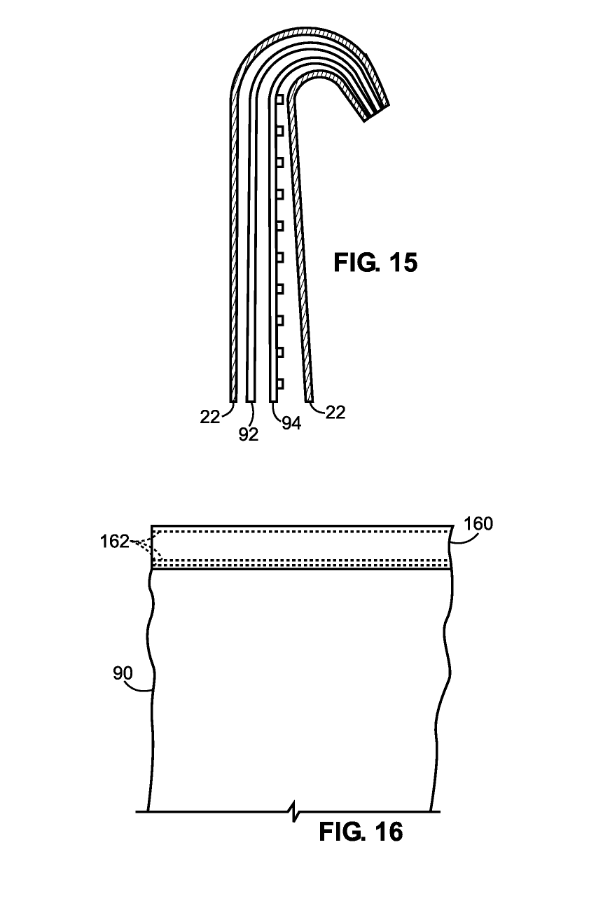

In assembling an insulating article 50, as in FIG. 5, an inner insulating layer 32 is cut to substantially the same size as outer layers 22 of article 50. Once the layers have been cut, they are placed one on top of the other in appropriate registration, as shown in the side section view of FIG. 15, and folded over as illustrated. The layers of material may be folded either once, twice or as many times as desired.

After folding into a hem 160 as shown in FIG. 16, all of the layers of the article 50 are stitched together by sewing 162 with a thread or filament, as described in U.S. Pat. No. 5,874,150, hereby incorporated by reference, of appropriate strength. Of course, the hem area 160 also may be secured by internal and external gluing, or by inserting a plurality of grommets or other fasteners. Stitching along the hem area may be a cost-effective and robust way to adhere the hem region such that the finished product exhibits increased structural integrity and performance in harsh environments.

### Example 15

An insulating article 60, as in FIG. 6, is assembled as explained in Example 13 or 14. A layer of closed cell or open cell foam 32 is laminated between two outer layers of HSPF 22.

### Example 16

An insulating article 70, as in FIG. 7, is assembled as explained in Example 13 or 14. A mesh layer 72 comprising a woven or non-woven reinforcing string layer is positioned adjacent an HSPF layer 22. These two layers are laminated between two outer polyethylene layers 42. Alternatively, one or both of the two outer polyethylene layers 42 may be an HSPF layer 22.

### Example 17

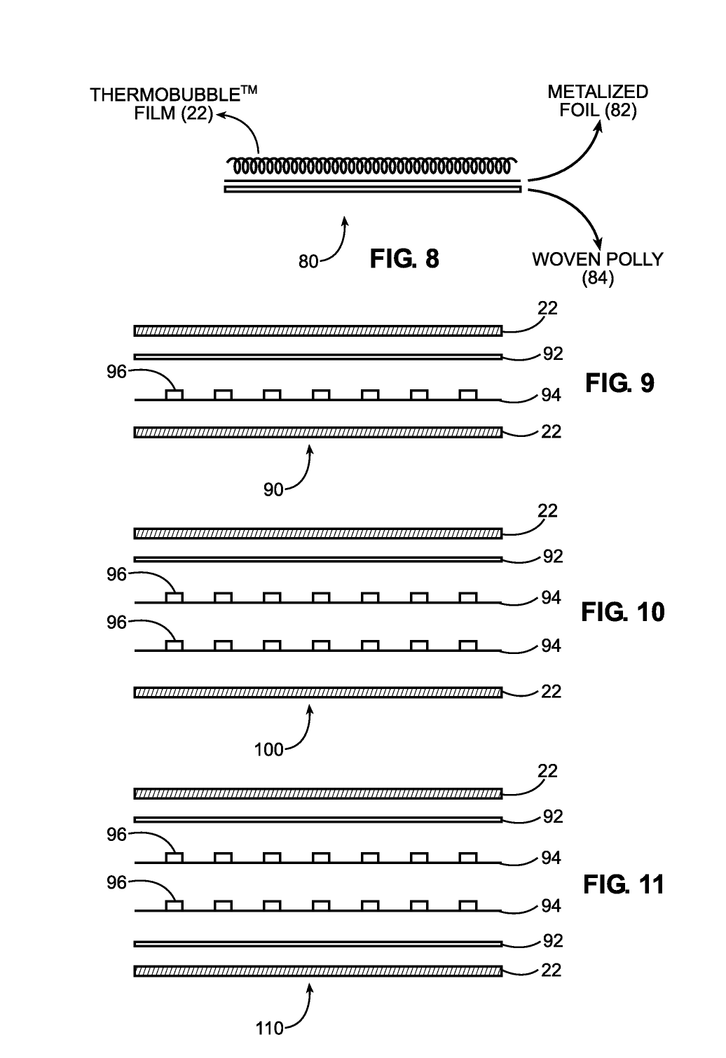

An insulating article 80, as in FIG. 8, is assembled as explained in Example 13 or 14. A woven polymer film layer 84 is covered with a metallization layer 82, which, in turn, is covered by an HSPF layer 22.

### Example 18

An insulating article 90, as in FIG. 9, is assembled as explained in Example 13 or 14. A polymer bubble layer 94 is positioned adjacent a metallization layer 92, and these layers are interdisposed between two HSPF layers 22.

### Example 19

An insulating article 100, as in FIG. 10, is assembled as explained in Example 13 or 14. The insulating article 100 is substantially similar to insulating article 90. However, two polymer bubble layers 94 are employed.

### Example 20

An insulating article 110, as in FIG. 11, is assembled as explained in Example 13 or 14. The insulating article 110 is substantially similar to insulating article 1100. However a second metallization layer 92 is provided.

### Example 21

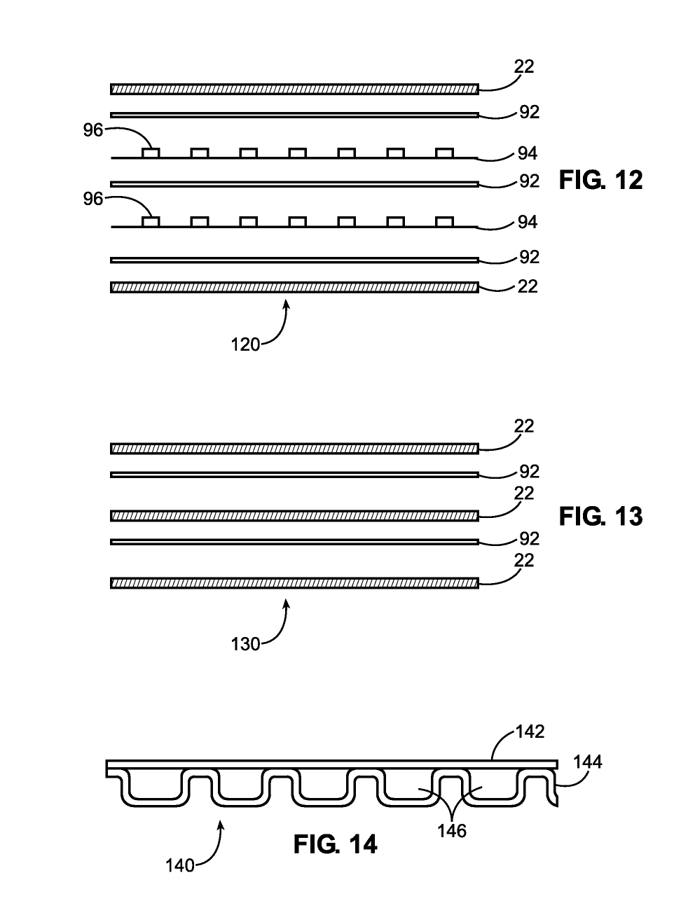

The insulating article 120 as in FIG. 12, is assembled as explained in Example 13 or 14. The insulating article 120 is substantially similar to insulating article 110. However, a third metallization layer 92 is provided between adjacent polymer bubble layers 94.

### Example 22

An insulating article 130, as in FIG. 13, is assembled as explained in Example 13 or 14. Insulating article 130 is substantially similar to insulating article 120. However, no polymer bubble layers 94 are present.

What is claimed is:

1. A heat insulating article, comprising:
a first outer polymeric layer;
a second outer polymeric layer;
wherein at least one of the first outer polymeric layer and the second outer polymeric layer further comprises hollow spherical particles incorporated with the at least one of the first outer polymeric layer and the second outer polymeric layer.

2. The heat insulating article of claim 1, wherein the hollow spherical particles comprise between about 2% to about 35% by weight of the at least one of the first outer polymeric layer and the second outer polymeric layer.

3. The heat insulating article of claim 2, wherein the hollow spherical particles comprise about 2% by weight of the at least one of the first outer polymeric layer and the second outer polymeric layer.

4. The heat insulating article of claim 2, wherein the hollow spherical particles comprise about 10% by weight of the at least one of the first outer polymeric layer and the second outer polymeric layer.

5. The heat insulating article of claim 2, wherein the hollow spherical particles comprise about 20% by weight of the at least one of the first outer polymeric layer and the second outer polymeric layer.

6. The heat insulating article of claim 2, wherein the hollow spherical particles comprise about 30% by weight of the at least one of the first outer polymeric layer and the second outer polymeric layer.

7. The heat insulating article of claim 1, wherein at least one of the first outer polymeric layer and the second outer polymeric layer comprises woven polyethylene.

8. The heat insulating article of claim 7, further comprising an insulating layer disposed between the first outer polymeric layer and the second outer polymeric layer.

9. The heat insulating article of claim 8, wherein the insulating layer comprises at least one of close cell foam, open cell foam and polymer bubble layer.

10. The heat insulating article of claim 1, further comprising a metallization layer applied to at least one of the first outer polymeric layer and the second outer polymeric layer.

11. The heat insulating article of claim 1, further comprising a metallization layer disposed between the first outer polymeric layer and the second outer polymeric layer.

12. The heat insulating article of claim 1, wherein the first outer polymeric layer further comprises a plurality of convolutions forming air spaces and the second outer polymeric layer bounds each of the plurality of convolutions and seals the air spaces.

13. The heat insulating article of claim 1, wherein the hollow spherical particles are coated with a metallization layer.

14. The heat insulating article of claim 1 wherein at least one of the first outer polymeric layer and the second outer polymeric layer includes an opaque polyethylene coating.
